(19) United States
(12) Patent Application Publication
(10) Pub. No.: US 2012/0243451 A1
(43) Pub. Date: Sep. 27, 2012

(54) OVERLAY FOR SCRAMBLER BITS IN A WIRELESS COMMUNICATION

(76) Inventors: Thomas J. Kenney, Portland, OR (US); Robert J. Stacey, Portland, OR (US)

(21) Appl. No.: 13/070,978

(22) Filed: Mar. 24, 2011

(51) Int. Cl. H04W 28/00

(52) U.S. Cl. 370/310

(57) ABSTRACT

By using an exclusive OR operation between two values to create a third value, a wireless communications device may communicate all three values to another device while only transmitting two of the values. In a particular embodiment, a bandwidth-static/dynamic parameter may be conveyed in a Request-to-Send by transmitting a length field and a scrambler seed to be used in the subsequent communication, with the bandwidth-static/dynamic parameter encoded into the scrambler seed. The receiving device may then derive the bandwidth-static/dynamic parameter by performing another XOR on portions of the two received parameters.

### BACKGROUND

In some types of wireless communications, a Request-to-Send and Clear-to-Send exchange may need to include information about the bandwidth to be used (generally 20, 40, 80, or 160 MHz) and whether that bandwidth will remain static or change dynamically during the ensuing communication. Three bits may be used to indicate both—two bits to indicate four choices of bandwidth and one bit to indicate static/dynamic. However, some existing conventional approaches do not have reserved bits available to be used for this purpose. Reassigning bits from another field would reduce the choices available from that other field, and would therefore be unsatisfactory.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a diagram of a wireless network, according to an embodiment of the invention.

FIG. 2 shows a diagram of a format for part of a packet for an RTS, according to an embodiment of the invention.

FIG. 3 shows a flow diagram of a method of encoding three values into two fields for transmission, according to an embodiment of the invention.

FIG. 4 shows a flow diagram of a method of decoding three values from two fields received in a transmission, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a non-transitory computer-readable medium, which may be read and executed by one or more processors to enable performance of the operations described herein. Such a computer-readable medium may include any tangible non-transitory mechanism for storing information in a form readable by one or more computers, such as but not limited to read only memory (ROM); random access memory (RAM); magnetic disk storage media; optical storage media; a flash memory device, etc.

The term “wireless” may be used to describe circuits, devices, systems, methods, techniques, communications channels, etc., that communicate data by using modulated electromagnetic radiation through a non-solid medium. The term does not imply that the associated devices do not contain any wires. A wireless device may comprise at least one antenna, at least one radio, at least one memory, and at least one processor, where the radio transmits signals through the antenna that represent data and receives signals through the antenna that represent data, while the processor may process the data to be transmitted and the data that has been received. The processor may also process other data which is neither transmitted nor received.

As used within this document, the term “network controller” is intended to cover devices that schedule and control, at least partially, wireless communications by other devices in the network. A network controller may also be known as a base station (BS), access point (AP), central point (CP), or any other term that may arise to describe the functionality of a network controller.

As used within this document, the term “mobile device” is intended to cover those devices whose wireless communications are at least partially scheduled and controlled by the network controller. A mobile device (MD) may also be known as a mobile station (MS), STA, subscriber station (SS), user equipment (UE), or any other term that may arise to describe the functionality of a mobile device. Mobile devices may move during such communications, but movement is not required.

As used in this document, channel bandwidth indicates the width of the channel in the frequency spectrum. In most cases, channels having higher bandwidth (‘wide’ channels, such as 40, 80, or 160 MHz) may be constructed by combining multiple predefined channels having the narrowest of the available bandwidths (a ‘narrow’ channel, such as 20 MHz). In some embodiments, the narrow channels that are thus combined will be adjacent in the frequency spectrum, so that the resulting ‘wide’ channel will occupy a contiguous frequency spectrum. But in some cases, the narrow channels that are combined into a wide channel will not all be adjacent, so the resulting wide channel may occupy non-contiguous portions of the frequency spectrum. This document describes how to indicate the total occupied bandwidth, but does not describe how to indicate contiguous or non-contiguous wide channels, nor does it describe how to indicate which frequencies are to be used.

In various embodiments, a first set of bits may be XOR'd with a second set of bits to produce a third set of bits, and the second and third sets of bits transmitted to another device. The receiving device may then XOR the second and third sets of bits to recreate the first set of bits. In this manner, three sets of bits may be conveyed while transmitting only two of those sets. This may be especially advantageous when the second and third sets of bits can be somewhat random in nature, and the transmitted packet does not have enough allocated bits to explicitly contain all three sets of bits.

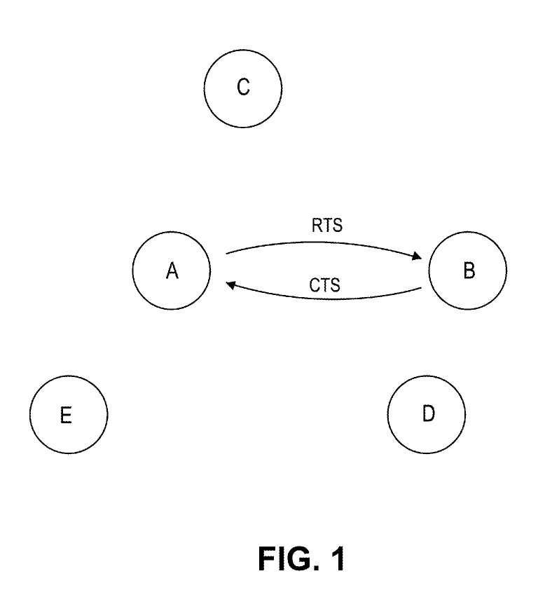

FIG. 1 shows a diagram of a wireless network, according to an embodiment of the invention. The illustrated network shows five network devices, labeled A, B, C, D and E. In some embodiments one of these devices may be a network controller, but in other embodiments they may all be peer devices. In the example, device A initiates a communication with device B by transmitting a Request-to-Send (RTS) to device B, and device B accepts the request by transmitting a Clear-to-Send (CTS) to device A. A subsequent communication may then take place between devices A and B. Although devices C, D and E are not involved in this exchange, each of them may be able to receive and decode at least one of the RTS and the CTS.

Although the basic concept of a requesting and agreeing to a communication may be simple, the RTS and CTS may contain additional information that pertains to that subsequent communication. For example, each may contain the addresses of the two devices to be involved in the communication, so that other devices will know not to use the channel(s) during that time. This may effectively ‘reserve’ the channel for that period of time by notifying other devices in the network to refrain from using the channel. If multiple channels are available for use, the RTS/CTS commands may specify which channel(s) are to be used, or alternately may be transmitted in parallel over each of the multiple channels.

In some embodiments, when devices A and B intend to communicate with each other, not only the channel, but the bandwidth of the channel may be selectable and therefore included in the RTS. In some embodiments that have the capability for selectable bandwidth, the bandwidth may or may not be allowed to change during the communication, and this information may also be included in the RTS. At the time of this writing, four different bandwidths were expected to become common (20, 40, 80, and 160 MHz), and thus two bits would be sufficient to indicate which of the four was to be used. But different bandwidths could be indicated by the same number of bits, and/or additional bandwidth selections could be indicated by more bits.

A single bit should be sufficient to indicate whether the bandwidth could (dynamic) or could not (static) be changed during the subsequent communication. Thus, three bits would be enough to indicate a selection of four bandwidths and the static/dynamic parameters being agreed to. However, the same principles may be extended to more bandwidth selections, and/or more bits may be included to specify other parameters.

An RTS may also carry information to encode the information in the subsequent communication, for security purposes. To assure a sufficient level of security, a random number generator may be used to as a ‘seed’ to initiate the scrambling, or encoding, of the data before transmission and the unscrambling of the data after reception. This seed may also be communicated in the RTS. Note: since the difference between a truly random number and a pseudo-random number is not universally agreed upon, the term ‘random’ is intended to include ‘pseudo-random’ when used in this document.

Although the bandwidth, static/dynamic, and scrambler seed parameters have been described as being in the RTS, in some embodiments the CTS may also contain such parameters, either as a way of verifying their value to the transmitter of the RTS, or as a way of changing their value.

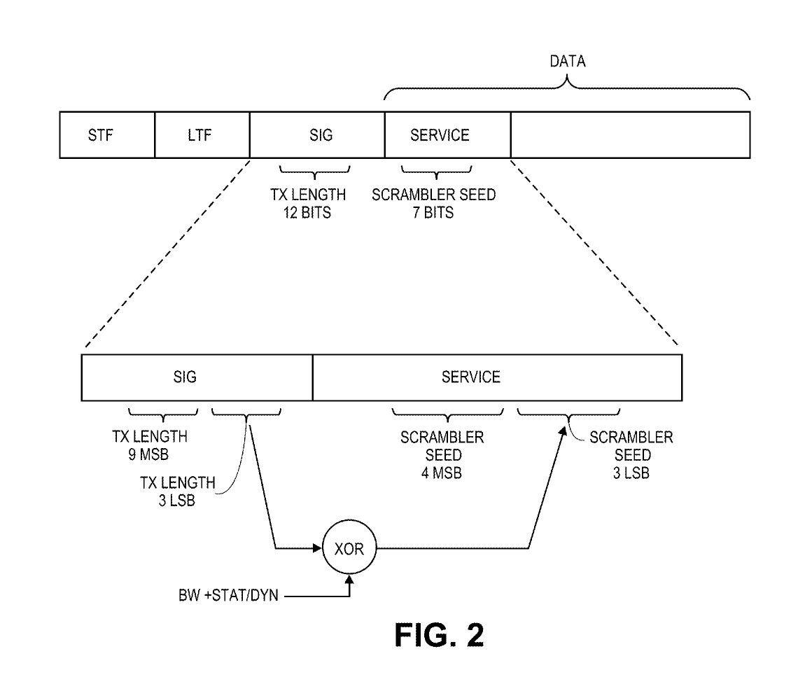

FIG. 2 shows a diagram of a format for part of a packet for an RTS, according to an embodiment of the invention. The description refers to an RTS, but the same format may also be applied to a CTS. Although the upper part of FIG. 2 may resemble the description in industry standard IEEE 802.11n—2009, part 20.3, this should not be interpreted as a limitation on the various embodiments of the invention, and other formats may be used.

The top of FIG. 2 shows a series of fields that may be contained in an RTS. The first two fields are a short training field (STF) and a long training field (LTF), which may be used to establish the communications link at the PHY level, and may allow the receiver to synchronize on the subsequent parts of the communication. The next field is shown as a Signal (SIG) field, which may contain various information. For example, the SIG field may contain a Length sub-field that defines the length of this packet.

The payload, or data, may follow, containing the information that is intended to be transferred between devices, and may contain other information as well. For example, it may contain a Service field, and the Service field may contain a scrambler seed that is to be used for encrypting the data in the subsequent communications exchange. The example shows a 7-bit scrambler seed, which allows for up to 128 scrambler initialization sequences. The scrambler seed may be a random number, further increasing the security level offered by this feature.

This example, without more, may not leave any reserved (i.e., unassigned) bits to be used for other purposes, such as bandwidth and static/dynamic designations. The lower part of FIG. 2 gives an example of how portions of these fields may be combined in a way that conveys the additional bits, without sacrificing the content of the existing fields.

In the illustrated example, 3 additional bits are conveyed without adding these bits to the packet, but other quantities of bits may be conveyed by using the same technique without deviating from the novel concepts of the embodiments of the invention. In this example, the bandwidth and static/dynamic information may be conveyed in 3 bits without that information being explicitly inserted into the packet. These three bits may actually be conveyed in the least significant bits (LSBs) of the scrambler seed, although not by being directly inserted into those positions. Since the scrambler seed is intended to be a random number, it does not matter what the value of the LSBs of the scrambler seed are as long as they are random.

To derive the LSBs of the scrambler seed, the bandwidth-static/dynamic bits may be combined with the three LSB of the length field through an exclusive OR (XOR) operation, and the result inserted into the scrambler seed. The example inserts the result into the LSBs of the scramber seed. Since the value in the length field (especially the least significant bits) may change substantially from one RTS to the next, and the bandwidth-static/dynamic bits may also change from one RTS to the next, the results of this XOR may be considered random, and the randomness of the scrambler seed is not diminished by any significant amount when this result is used as the LSBs of the scrambler seed.

Although other types of Boolean operations might be used, the advantage of an XOR is that the original values may be retrieved by performing another XOR on the results. For example, if the transmitting device performs an XOR between a first value and a second value to derive a third value, it might then transmit only the second and third values. But the receiving device may derive the first value by performing an XOR between the second and third values. As long as the third value may be treated as random and at least one of the first and second values are sufficiently variable, this technique should not effectively limit the values that can be communicated in this manner.

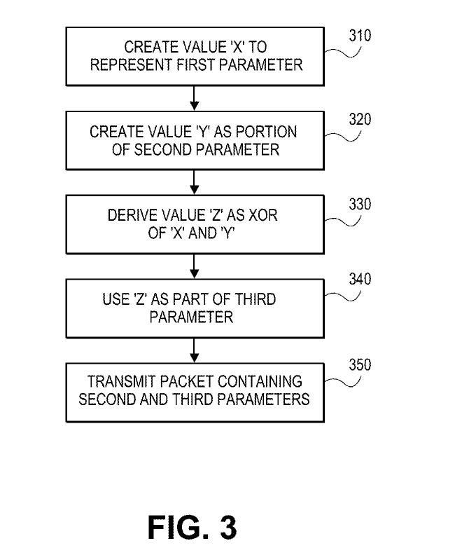

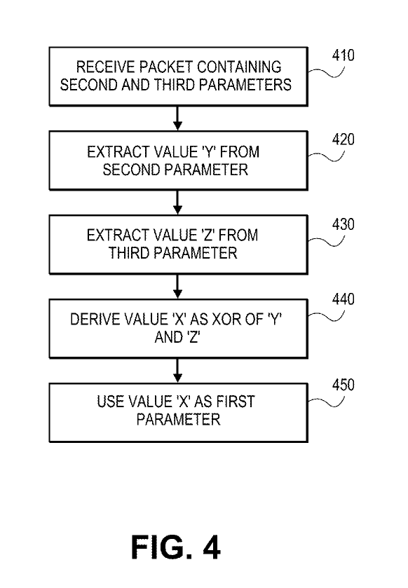

FIG. 3 shows a flow diagram of a method of encoding three values into two fields for transmission, according to an embodiment of the invention. In FIGS. 3 and 4, value X may be the first parameter, value Y may correspond to a portion of the second parameter, and value Z may correspond to a portion of the third parameter.

At 310, a wireless communication device may create a value X to represent a first parameter such as the bandwidth-static/dynamic parameter for a subsequent communication. At 320 the device may create a value Y to represent a portion (such as the LSBs) of a second parameter (such as the Length field describing this packet). At 330 the device may perform an exclusive OR operation between the bits of value X and value Y to produce a value Z.

This value Z may then be used as part (such as the LSBs) of a third parameter (such as a scrambler seed) at 340. The second and third parameters may then be used to construct a packet that is transmitted to another device at 350. In some embodiments, the packet may be part of an RTS that is used to establish the subsequent communication with that other device.

FIG. 4 shows a flow diagram of a method of decoding three values from two fields received in a transmission, according to an embodiment of the invention. If the operations of FIG. 3 are performed by a device transmitting a packet, the operations of FIG. 4 may be performed by a device receiving that packet. The values X, Y, Z, as well as the first, second, and third parameters, may correspond to similarly-named items in FIG. 3.

At 410, a device may receive a packet containing the second and third parameters (such as the length field and the scrambler seed). At 420 the device may extract the value Y (such as the LSBs) from the second parameter (such as the Length field), and at 430 extract the value Z (such as the LSBs) from the third parameter (such as the scrambler seed). At 440 the device may perform an exclusive OR operation between values Y and Z to obtain value X. The value X may then be used as a first parameter (such as an indicator of bandwidth and static/dynamic status) by the device at 450.

In the preceding examples, it has been assumed that the value X and the first parameter were the same; i.e., the value X was the full first parameter. But in other embodiments the value X may be a subset of the first parameter. Similarly, in the preceding examples, it has been assumed that the value Y was a subset of the second parameter and the value Z was a subset of the third parameter. But in other embodiments, the value Y may be the full second parameter, and/or the value Z may be the full third parameter.

The foregoing description is intended to be illustrative and not limiting. Variations will occur to those of skill in the art. Those variations are intended to be included in the various embodiments of the invention, which are limited only by the scope of the following claims.

What is claimed is:

1. A method, comprising:
performing an exclusive OR operation between a first value and a second value to obtain a third value;
placing the second and third values into a packet; and
transmitting the packet to another device, the packet containing the second and third values but not containing the first value;
wherein the first and third values each represent information to be used in a subsequent communication with the other device.

2. The method of claim 1, wherein the packet is part of a either a request-to-send or a clear-to-send.

3. The method of claim 1, wherein the second value is at least part of a field defining a length of the packet.

4. The method of claim 1, wherein the first value includes a bandwidth indicator and a static/dynamic indicator for the subsequent communication.

5. The method of claim 1, wherein the third value is at least part of a scrambler seed for the subsequent communication.

6. An apparatus comprising a wireless communications device having a processor, a memory, and a radio, the device capable of:
performing an exclusive OR operation between a first value and a second value to obtain a third value;
placing the second and third values into a packet; and
transmitting the packet to another device, the packet containing the second and third values but not containing the first value;
wherein the first and third values each represent information to be used in a subsequent communication with the other device.

7. The apparatus of claim 6, wherein the packet is part of a either a request-to-send or a clear-to-send.

8. The apparatus of claim 6, wherein the second value is at least part of a field defining a length of the packet.

9. The apparatus of claim 6, wherein the first value includes a bandwidth indicator and a static/dynamic indicator for the subsequent communication.

10. The apparatus of claim 6, wherein the third value is at least part of a scrambler seed for the subsequent communication.

11. An article comprising
a computer-readable non-transitory storage medium that contains instructions, which when executed by one or more processors result in performing operations comprising:
performing an exclusive OR operation between a first value and a second value to obtain a third value;
placing the second and third values into a packet; and
transmitting the packet to another device, the packet containing the second and third values but not containing the first value;
wherein the first and third values each represent information to be used in a subsequent communication with the other device.

12. The article of claim 11, wherein the packet is part of a either a request-to-send or a clear-to-send.

13. The article of claim 11, wherein the second value is at least part of a field defining a length of the packet.

14. The article of claim 11, wherein the first value includes a bandwidth indicator and a static/dynamic indicator for the subsequent communication.

15. The article of claim 11, wherein the third value is at least part of a scrambler seed for the subsequent communication.

16. A method, comprising:
receiving a packet in a wireless communication from another wireless device, the packet containing a second value and a third value;
performing an exclusive OR operation between the second value and the third value to obtain a first value; and
using the first and third values in a subsequent communication with the other wireless device.

17. The method of claim 16, wherein the packet is part of a either a request-to-send or a clear-to-send.

18. The method of claim 16, wherein the second value is at least part of a field defining a length of the packet.

19. The method of claim 16, wherein the first value includes a bandwidth indicator and a static/dynamic indicator for the subsequent communication.

20. The method of claim 16, wherein the third value is at least part of a scrambler seed for the subsequent communication.

21. An apparatus comprising a wireless communications device having a processor, a memory, and a radio, the device to:
receive a packet in a wireless communication from another wireless device, the packet containing a second value and a third value;
perform an exclusive OR operation between the second value and the third value to obtain a first value; and
use the first and third values in a subsequent communication with the other wireless device.

22. The apparatus of claim 21, wherein the packet is to be part of a either a request-to-send or a clear-to-send.

23. The apparatus of claim 21, wherein the second value is to be at least part of a field defining a length of the packet.

24. The apparatus of claim 21, wherein the first value is to include a bandwidth indicator and a static/dynamic indicator for the subsequent communication.

25. The apparatus of claim 21, wherein the third value is to be at least part of a scrambler seed for the subsequent communication.

26. An article comprising
a computer-readable non-transitory storage medium that contains instructions, which when executed by one or more processors result in performing operations comprising:
receiving a packet in a wireless communication from another wireless device, the packet containing a second value and a third value;
performing an exclusive OR operation between the second value and the third value to obtain a first value; and
using the first and third values in a subsequent communication with the other wireless device.

27. The article of claim 26, wherein the packet is part of a either a request-to-send or a clear-to-send.

28. The article of claim 26, wherein the second value is at least part of a field defining a length of the packet.

29. The article of claim 26, wherein the first value includes a bandwidth indicator and a static/dynamic indicator for the subsequent communication.

30. The article of claim 26, wherein the third value is at least part of a scrambler seed for the subsequent communication.
